(19) United States
(12) Patent Application Publication
(10) Pub. No.: US 2017/0228677 A1
(43) Pub. Date: Aug. 10, 2017

(54) LOCAL FACTORS ANALYSIS IN LOCALIZED VIRTUAL STORE FOR CONFIGURING A PRODUCTS PORTFOLIO

(71) Applicant: International Business Machines Corporation, Armonk, NY (US)

(72) Inventors: RAPHAEL EZRY, New York, NY (US); Ambhighainath Ganesan, White Plains, NY (US); Munish Goyal, Yorktown Heights, NY (US); Avinash Kalyanaraman, Southboro, MA (US); Jorge Malibran Angel, Nanuet, NY (US); Alison C. Wessner, New Canaan, CT (US)

(73) Assignee: International Business Machines Corporation, Armonk, NY (US)

(21) Appl. No.: 15/016,595

(22) Filed: Feb. 5, 2016

(51) Int. Cl. G06Q 10/06; G06Q 30/02

(52) U.S. Cl. CPC G06Q 10/06315; G06Q 30/0205

(57) ABSTRACT

A set of factors affecting a sold volume of the product is collected at a store in a geographical portion of a geographical area. A subset of a set of area stores is identified having a corresponding sold volume of the product. An intrinsic capacity of the product is computed by adjusting the sold volume of an area store by a first volume where the first volume is due to a sale of a second product at the area store. A modified intrinsic capacity is computed by modifying an effect of a factor from the subset on the intrinsic capacity such that the effect is worse than an effect of the factor at the store. A virtual store is constructed using modified intrinsic capacities of a sub-subset of area stores. A target volume of the product is set at the store as the virtual intrinsic capacity at the virtual store.

### TECHNICAL FIELD

The present invention relates generally to a method, system, and computer program product for changing the product offerings in a store. More particularly, the present invention relates to a method, system, and computer program product for local factors analysis in localized virtual store for configuring a product portfolio.

### BACKGROUND

Retail stores in neighborhoods, cities, regions, and other similarly configured geographical areas stock a variety of products for sale. Consumer goods, such as bath supplies, household cleaning products, packaged foods or beverages, and the like are some example of such products commonly retailed at stores.

For the retailers as well as the manufacturers of the products, it is important to know whether a store is achieving the best possible sales volume for a product, and how much improvement in that sales volume is possible. It is also important for the retailers and manufacturers to gain insight into the various product combinations that are suitable for a store location and the expected sales volumes when those product combinations are stocked there.

### SUMMARY

The illustrative embodiments provide a method, system, and computer program product. An embodiment includes a method that collects, for a product at a store in a geographical portion of a geographical area, a set of factors, each factor in the set of factors affecting a sold volume of the product. The embodiment identifies a subset of a set of area stores such that each area store in the subset of area stores has a corresponding sold volume of the product. The embodiment computes an intrinsic capacity of the product by adjusting the sold volume corresponding to an area store by a first volume, where the first volume is due to a sale of a second product at the area store. The embodiment selects from the subset of area stores, a sub-subset of area stores where the sold volume corresponding to an area store in the sub-subset is affected by at least a subset of the set of factors, the sub-subset including the area store. The embodiment modifies, to compute a modified intrinsic capacity, an effect of a factor from the subset of factors on the intrinsic capacity of the product such that the effect is worse than an effect of the factor at the store. The embodiment constructs a virtual store using modified intrinsic capacities of the sub-subset of area stores. The embodiment sets as an upper threshold of target volume of the product at the store, a virtual intrinsic capacity of the product at the virtual store.

An embodiment includes a computer program product. The computer program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of a portion of an example configuration for local factors analysis in localized virtual store for configuring a product portfolio in accordance with an illustrative embodiment;

FIG. 4 depicts a block diagram of another portion of an example configuration for local factors analysis in localized virtual store for configuring a product portfolio in accordance with an illustrative embodiment; and

FIG. 5 depicts a flowchart of an example process for local factors analysis in localized virtual store for configuring a product portfolio in accordance with an illustrative embodiment.

### DETAILED DESCRIPTION

The illustrative embodiments recognize that the sales at a given store is highly dependent upon local environment factors. A local environment factor is a factor that relates to the geographical portion of the geographical area—e.g., a neighborhood in a city or a street in a neighborhood and the like—in which the store is located, a characteristic of the store, or a combination thereof. Some examples of local environmental factor include but are not limited to income, ethnicity, and other demographics of the geographical portion; price markups at the store; size of the store; inter-store competition in the geographical portion; accessibility of the store; and many others.

A subset of a set of local environmental factors may affect the sale of a particular product. Different subsets of local environmental factors can affect the sales of different products differently. For example, suppose that a first product is an essential product, such as a bar of soap, and a second product is a luxury item, such as a makeup product. Further suppose that a given store in a given geographical portion sells both products A and B. The local environmental factor of income demographic of the neighborhood likely affects the sale of the first product less than it affects the sale of the second product.

The effect of a local environmental factor on the sale of a product has a polarity. If a local environmental factor improves the sale of the product, the local environmental factor's effect has a positive polarity. If a local environmental factor is detrimental to the sale of the product, the local environmental factor's effect has a negative polarity. As some examples, if the local environmental factor of a store is higher than a threshold income demographic, and the local environmental factor increases the sale of a product due to the higher than threshold income demographic, that local environmental factor is said to have a positive polarity. How much that local environmental factor affects the sale of the product is a measure of the intensity of the local environmental factor's effect on the sale of the product. As a non-limiting example, an effect of a local environmental factor on the sale may be severe, moderate, or negligible. The local environmental factor will accordingly have a corresponding intensity with a suitable polarity. Similarly, if the local environmental factor of a store is higher than a competitive store pricing, and the local environmental factor decreases the sale of a product due to the higher than the competitive store pricing, that local environmental factor is said to have a negative polarity, with a suitable intensity.

The illustrative embodiments further recognize that the sales of a product can be dependent on or affected by sales of other products at the same store. For example, if the store only sells soap, it might sell 100 bars of soap versus when the store sells both soap and shampoo, it might sell 50 bars of soap and 50 bottles of shampoo.

The illustrative embodiments recognize that interdependencies between products can take various forms. Some products are interdependent by being substitutable with one another. Soap and shampoo can be regarded as substitutable in the above example. Some products are interdependent by being complementary to one another. Shampoo and conditioner can be regarded as complementary because the more is the sale of shampoo, the more is the sale of conditioner. Some products are interdependent by being co-dependent or supplementary to one another such that one product would not sell unless the other was sold as well.

These and many other types of direct and indirect interdependencies are similarly possible between products at a store. Generally, products can be interdependent on one or more other products in one or more different ways. A product interdependency model is a representation to describe such product interdependencies. In the simplest form, the product interdependency model may be a spreadsheet or a matrix listing the relationship of each product in a set of products with some or all other products in the product set. The product interdependency model can take any suitable form within the scope of the illustrative embodiments.

Furthermore, a product interdependency model indicates an amount or extent of the interdependency between two interdependent products. For example, products A and B may be interdependent but only occasionally or marginally, whereas products A and C may be tightly or highly interdependent. The level, amount, or extent of interdependency between two products can be represented on a numeric or other suitable scale within a product interdependency model.

The sales of products at a store are also a factor of seasonality of the products, weather and other environmental changes, occasional and event-related variations, and many other factors. The illustrative embodiments recognize that determining whether a store's sales of a product are achieving the maximum potential target is difficult given the numerous local environmental factors, product interdependencies, and other factors.

The illustrative embodiments also recognize that whether certain quantities or a product can be sold at a store, whether certain combinations of products can be sold at the store, whether certain quantities of certain products in a combination can be sold at the store is another complex problem.

The product quantities, products, and product combinations are further dependent upon constraints that the store, the retailer, the manufacturer, or a combination thereof place on the sales at the store. For example, profitability thresholds may preclude less profitable products in a combination; shelf-space availability may preclude certain quantities; local regulations may preclude the sale of certain products.

The illustrative embodiments recognize that determining a suitable combination of products to sell at a store given a variety of constraints is another difficult problem.

The illustrative embodiments used to describe the invention generally address and solve the above-described problems and other problems related to local factors analysis in localized virtual store for configuring a product portfolio.

An embodiment can be implemented as a software application. The application implementing an embodiment can be configured as a modification of an analytics engine or a control component, as a separate application that operates in conjunction with an existing analytics engine or control component, a standalone application, or some combination thereof.

Only as a non-limiting example, and for the purposes of the clarity of the description, a city is used as an example geographical area and a neighborhood in the city is used as an example geographical portion within the geographical area. Assume that an actual store is located in the neighborhood (the store in question). As a first part of a problem solved by the illustrative embodiments, the illustrative embodiments have to find a target volume—an upper threshold volume—of a product—product A—which can be sold from the store over a period. As a second part of the problem, the illustrative embodiments have to find a product combination—product A and product B, in quantities A and B respectively—which should be sold at the store to meet or exceed a target.

Many stores are located within the city. Different stores stock different products, have different local environmental factors, other factors, and constraints under which they each sell various products. Some or all such other stores in the city may sell product A.

An embodiment collects the store-by-store product sales data (hereinafter interchangeably referred to product-store sale data). The product-store sale data is for a set of stores in the city. The embodiment selects that product-store sale data which pertains to the sale of a selected product, e.g., product A. Suppose that a first subset of stores contributed the product-store sale data for product A.

Using one or more product interdependency models, the embodiment isolates the product interdependency effects from the sale data of the sale of product A. For example, if product B increased the sale of product A at one store in the product-store sale data, the embodiment removes or minimizes that increase attributed to product B. Similarly, as another example, if product C decreased the sale of product A at another store in the product-store sale data, the embodiment removes or minimizes that decrease attributed to product C. By isolating and removing or minimizing the product interdependency effects from the product-store sale data, the embodiment computes an intrinsic capacity of product A at the first subset of stores.

The embodiment then identifies a set of local environmental factors that affect the sale of product A at the store in question. For each local environmental factor in the set of local environmental factors, the embodiment determines a polarity and an intensity of the local environmental factor.

From the first subset of stores, the embodiment selects a sub-subset of those stores (second subset of stores) that have at least a subset of the set of local environmental factors affecting the sale of product A in those stores. In one embodiment, the polarity and/or intensity of a local environmental factor from the set of local environmental factors is adjusted for a store in the second subset of stores such that the local environmental factor has a worse effect on the sale of product A in that store as compared to the effect of the same local environmental factor on the sale of product A at the store in question. In another embodiment, the second subset of stores is selected such that a store in the second subset has a local environmental factor from the set of local environmental factors with a worse effect on the sale of product A as compared to the effect of the same local environmental factor on the sale of product A at the store in question.

For example, if the local environmental factor affecting the sale of product A at the store in question were the income demographic of the neighborhood which had a positive polarity, one embodiment selects a store where the income demographic had a negative polarity. Another embodiment selects a store where the income demographic is a local environmental factor and adjusts the intrinsic capacity such that the income demographic has a negative polarity on the sale of product A.

Thus, an embodiment produces a second subset of stores and modified intrinsic capacities at its member stores based on inverse or suppressed (worse) polarities of the local environmental factors from the store in question. Using the second subset, the embodiment constructs a virtual store. The virtual store combines the modified intrinsic capacities for product A from the second subset of stores to produce a virtual intrinsic capacity for the virtual store. The virtual intrinsic capacity of the virtual store is the volume a virtual store would sell even if the polarities of the local environmental factors were worse for the virtual store than of the local environmental factors for the store in question. The embodiment sets the target volume for product A at the store in question as the virtual intrinsic capacity. The second subset is so chosen to maximize the virtual intrinsic capacity. By default, if no such subset could be found, the store in question would be a member of the second subset and the virtual intrinsic capacity would be the same as the intrinsic capacity of product A for the store in question. Therefore, within the scope of the illustrative embodiments, the virtual intrinsic capacity of product A is the maximal intrinsic sale capacity of product A under the environmental factors which are worse than that for the store in question.

Operating in this manner, using the product-store sale data and the product interdependency models, an embodiment can compute the virtual intrinsic capacities for any number of products at the various stores in the set of stores. One embodiment uses a set of intrinsic capacities for a corresponding set of products to determine one or more product combinations that might be suitable for the store in question.

Specifically, the embodiment modifies the intrinsic capacities of the set of products by re-introducing the product dependencies from the product interdependency model, which were isolated and removed earlier. For example, if the intrinsic capacity of soap alone was 100 units, the shampoo alone was 100 units, by re-introduction of the substitutive interdependency between the soap and the shampoo products, the embodiment recomputes the dependent intrinsic capacity of the soap product to be 60 and the shampoo product to be 50. The embodiment produces a matrix of interdependent product combinations and their respective dependent intrinsic capacities.

The embodiment obtains a set of constraints that is applicable to the store in question. Using the set of constraints, the embodiment selects from the matrix one or more product combinations which satisfy at least a subset of the set of constraints. The embodiment outputs the selected product combinations and their corresponding dependent intrinsic capacities as the recommended product combinations and their target volumes for the store in question.

Once the product combinations are deployed at the store in question, an embodiment continues to collect product-store sale data for the products in the combination. Periodically or upon certain events, the embodiment, through continuous learning, performs one or more of the operations described herein to recompute the target volume of a product, a product combination, dependent intrinsic capacities of a product combination, or some combination thereof for the store in question.

A method of an embodiment described herein, when implemented to execute on a device or data processing system, comprises substantial advancement of the functionality of that device or data processing system towards local factors analysis in localized virtual store for configuring a product portfolio. For example, presently available methods for determining whether a store sold enough of a product is to compare the sales to a preset sales target or do a store-by-store comparison. An embodiment provides a method by which a store in question's specific local environmental factors, other factors, and product interdependencies are taken into account in constructing a virtual store. An embodiment compares the performance of the virtual store and the store in question for the same product when the virtual store is subjected to comparatively worse effects of local environmental factor. Based on the comparison, an embodiment recommends a suitable target at least equal to the intrinsic capacity of the product in the virtual store. By reintroducing product dependencies and factoring in store constraints, an embodiment further recommends product combinations and corresponding target quantities for a specific store. This manner of local factors analysis in localized virtual store for configuring a product portfolio is unavailable in the presently available methods. Thus, a substantial advancement of such devices or data processing systems by executing a method of an embodiment is in ensuring that the right store stocks the right product in the right proportion during a period to maximize sales and boost revenue.

The illustrative embodiments are described with respect to certain geographical areas, geographical portions, stores, products, sales volumes, interdependencies, local environmental factors, other factors, constraints, thresholds, combinations, models, matrices, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

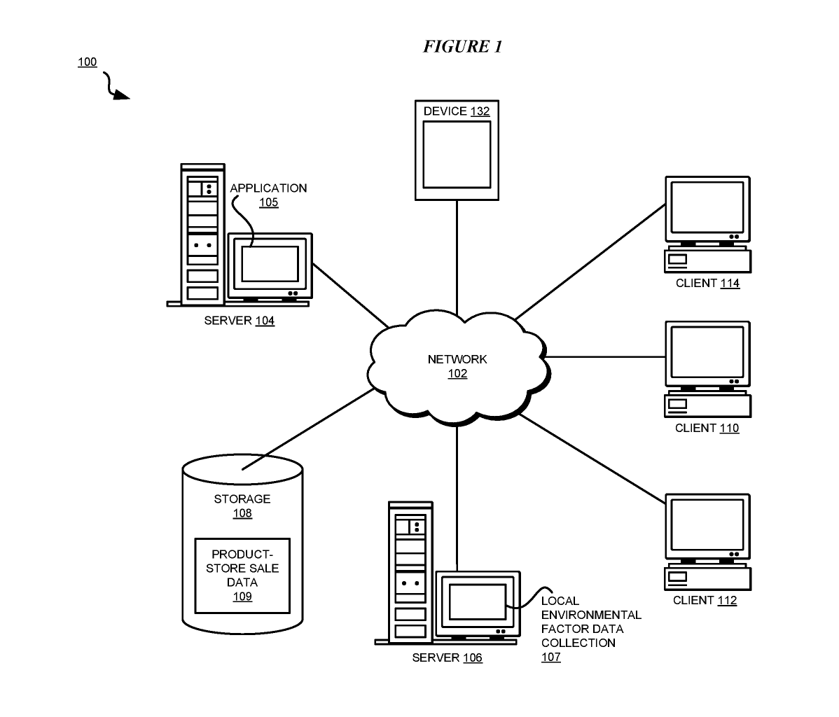

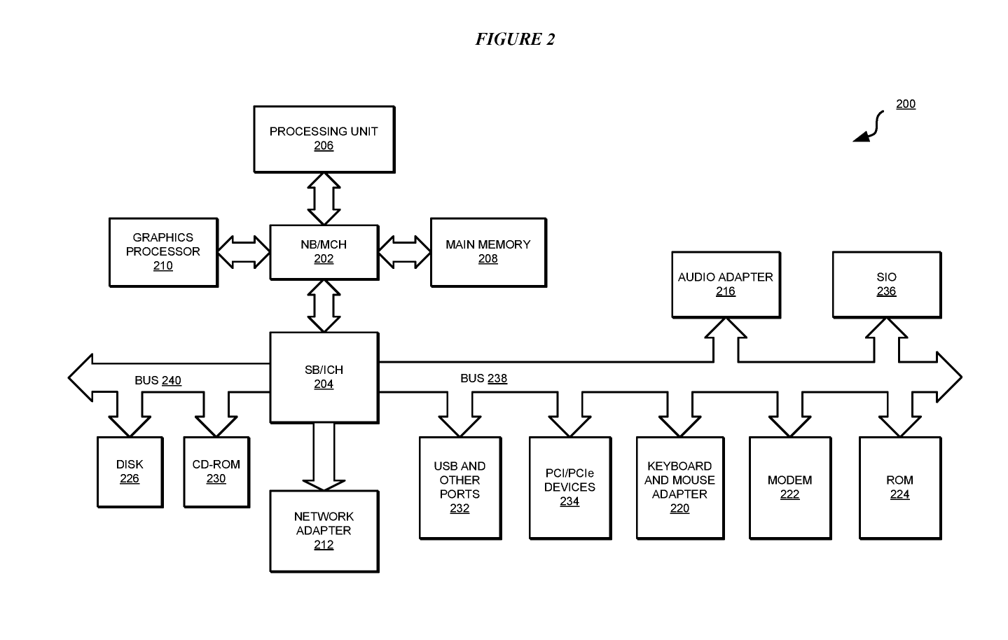

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Product-store sale data 109 is collected from a set of stores operating in a given geographical area. Local environmental factor data collection module 107 operates to collect a set of local environmental factors that are applicable to the sale of a product at a store in a geographical portion of the geographical area. Module 107 operates according to an embodiment described herein and may be implemented as a part of application 105, to execute in the same or different data processing systems relative to application 105.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

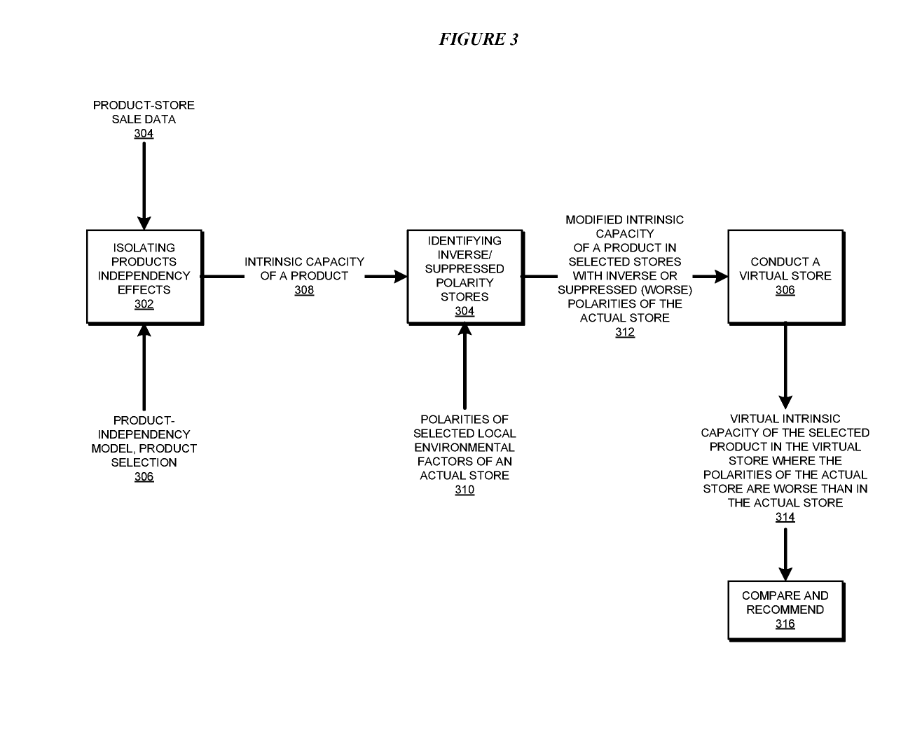

With reference to FIG. 3, this figure depicts a block diagram of a portion of an example configuration for local factors analysis in localized virtual store for configuring a product portfolio in accordance with an illustrative embodiment. Operations 302, 304, 306, and 316 are implemented in any suitable manner in application 105 in FIG. 1. Product-store sale data 304 is an example of product-store sale data 109 in FIG. 1 and pertains to stores in the geographical area within a portion of which the store in question is located. Assume that an objective of the depiction of FIG. 3 is to compute a target sales volume for product A at the store in question.

Operation 302 accepts product-store sale data 304 and one or more product interdependency models 306 as inputs. Using one or more product interdependency model 306, operation 302 identifies one or more interdependencies between product A and other products in product-store sale data 304. Operation 302 removes or minimizes the effects of such interdependencies on the sales data of product A in product-store sale data 304 to produce intrinsic capacity 308 of product A in each store that contributed sales data of product A in product-store sale data 304. These stores form the first subset as described earlier.

Operation 304 selects from the first subset of stores, a sub-subset—the second subset of stores—as described earlier. Specifically, operation 304 identifies the polarities and intensities of set 310 of local environmental factors that affect the sale of product A at the store in question. Operation 304 uses the identified local environmental factors to select the second subset of stores such that each member of the second subset is affected by at least a subset of the local environmental factors that affect the sale of product A at the store in question.

For a store in this second subset of stores, operation 304 inverses the polarities of a local environmental factor from the subset of local environmental factors, or otherwise suppresses or modifies the polarity, the intensity, or a combination thereof, of the applicable local environmental factor such that local environmental factor's effect on the sale of product A is worse at that store than at the store in question. Thus, operation 304 produces modified intrinsic capacities 312 for product A at each store in the second subset of stores.

Operation 306 uses the second subset of stores to construct a virtual store. Specifically, operation 306 combines the modified intrinsic capacities 312 of product A to produce virtual intrinsic capacity 314 of product A in the virtual store, where the virtual store has worse effects of local environmental factors 310 on the sale of product A than the store in question.

Operation 316 compares virtual intrinsic capacity 314 with the actual sales volume of product A at the store in question. If virtual intrinsic capacity 314 exceeds the actual sales, operation 316 recommends that the store in question should be able to at least sell virtual intrinsic capacity 314 quantities of product A if the virtual store can sell that quantity under worse local environmental factors.

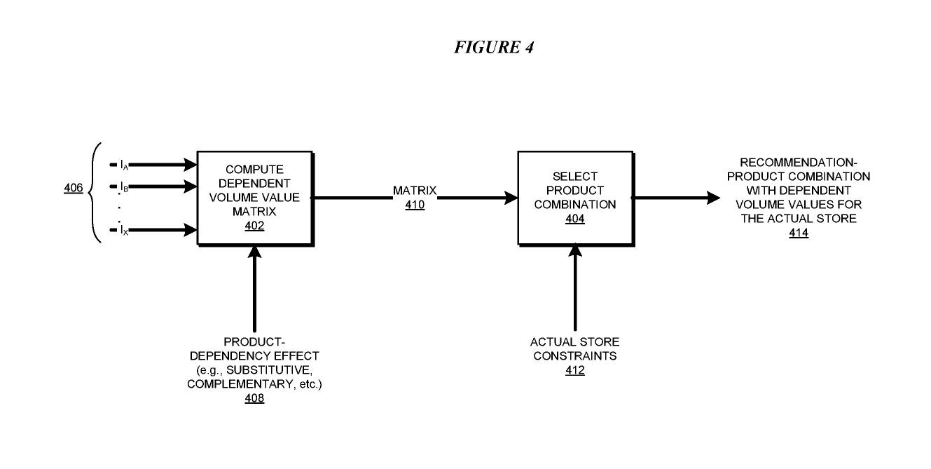

With reference to FIG. 4, this figure depicts a block diagram of another portion of an example configuration for local factors analysis in localized virtual store for configuring a product portfolio in accordance with an illustrative embodiment. Operations 402 and 404 are implemented in any suitable manner in application 105 in FIG. 1. Assume that another objective of application 105 is to compute a combination of products including product A, which can be sold at the store in question to improve store performance.

Operating in the manner of FIG. 3, an embodiment can compute the intrinsic capacities for any number of products at the various stores in the set of stores in the geographical area. Operation 402 accepts as inputs set 406 of intrinsic capacities, e.g., intrinsic capacities of products A, B, . . . X.

Operation 402 modifies the intrinsic capacities of set 406 by re-introducing effects 408 of product dependencies from the product interdependency model, which were isolated and removed in operation 302 in FIG. 3. The embodiment computes and produces matrix 410 of interdependent product combinations and their respective dependent intrinsic capacities.

Operation 404 obtains set 412 of constraints that is applicable to the store in question. Using set 412 of constraints, operation 404 selects from matrix 410 one or more product combinations involving product A, which satisfy at least a subset of set 412 of constraints. Operation 404 outputs the selected product combinations and their corresponding dependent intrinsic capacities as recommended product combinations 414 and their target volumes for the store in question.

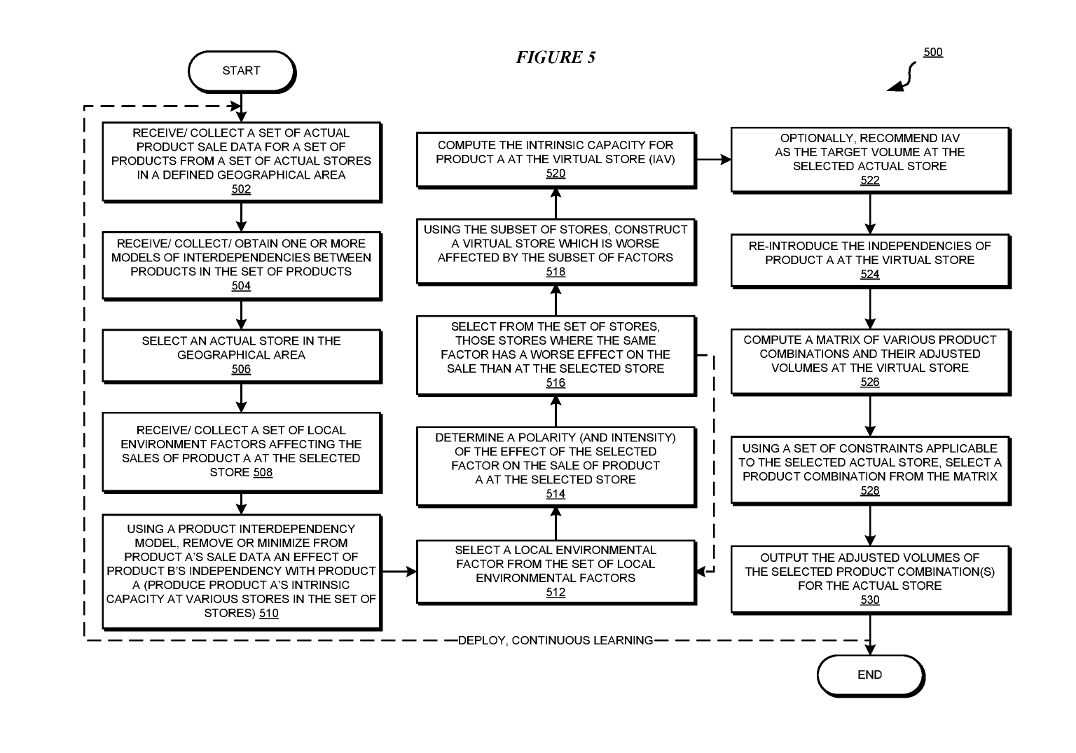

With reference to FIG. 5, this figure depicts a flowchart of an example process for local factors analysis in localized virtual store for configuring a product portfolio in accordance with an illustrative embodiment. Process 500 can be implemented in application 105 in FIG. 1.

The application receives or collects a set of actual product-store sale data for a set of products from a set of actual stores in a defined geographical area (block 502). The application receives, collects, or otherwise obtains one or more product interdependency models for interdependencies between the products in the set of products (block 504).

The application selects an actual store in the geographical portion of the geographical area, to wit, the store in question (block 506). The application receives or collects a set of local environmental factors affecting the sales of product A at the store in question (block 508). Using a product interdependency model, the application removes or minimizes from product A's sales data an effect of product B's interdependency with product A (block 510). Thus, the application computes the intrinsic capacities of product A at various stores in the set of stores.

The application selects a local environmental factor from the set of local environmental factors (block 512). The application determines a polarity, and optionally an intensity, of the effect of the selected local environmental factor on the sale of product A at the store in question (block 514). The application selects into a subset from the set of stores those stores where the same local environmental factor has a worse effect on the sale of product A than at the store in question (block 516). The application repeats blocks 512, 514, and 516 for a subset of local environmental factors.

Using the subset of stores, the application constructs a virtual store on which the effect of the subset of local environmental factors is worse than on the store in question (block 518). The application computes the intrinsic capacity of product A at the virtual store under such worse local environmental factors (block 520). Optionally, the application recommends the computed intrinsic capacity of product A at the virtual store as the target volume for product A at the store in question (block 522).

The application re-introduces the interdependencies of product A at the virtual store (block 524). The application computes a matrix, the matrix presenting various product combinations and their adjusted intrinsic capacities at the virtual store (block 526).

The application uses a set of constraints that is applicable at the store in question, to select a product combination from the matrix (block 528). The application outputs the adjusted volumes of the selected product combination(s) as a deployment recommendation for the store in question (block 530). The application ends process 500 thereafter.

In one embodiment, the application continues to collect the product-store sale data after the deployment of the product combinations of block 530. The product-store sale data, the product interdependency models, the local environmental factors, the constraints, and many other factors may change during the deployment. The application returns to block 502 and begins process 500 with the revised product-store sale data, product interdependency models, local environmental factors, constraints, other factors, or some combination thereof, and recomputes new target volumes for one or more products and/or product combinations.

Thus, a computer implemented method, system or apparatus, and computer program product are provided in the illustrative embodiments for local factors analysis in localized virtual store for configuring a product portfolio. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
collecting, for a product at a store in a geographical portion of a geographical area, a set of factors, each factor in the set of factors affecting a sold volume of the product;
identifying a subset of a set of area stores such that each area store in the subset of area stores has a corresponding sold volume of the product;
computing an intrinsic capacity of the product by adjusting the sold volume corresponding to an area store by a first volume wherein the first volume is due to a sale of a second product at the area store;
selecting from the subset of area stores, a sub-subset of area stores wherein the sold volume corresponding to an area store in the sub-subset is affected by at least a subset of the set of factors, the sub-subset including the area store;
modifying, to compute a modified intrinsic capacity, an effect of a factor from the subset of factors on the intrinsic capacity of the product such that the effect is worse than an effect of the factor at the store;
constructing a virtual store using modified intrinsic capacities of the sub-subset of area stores; and
setting as an upper threshold of target volume of the product at the store, a virtual intrinsic capacity of the product at the virtual store.

2. The method of claim 1, further comprising:
adjusting by a second volume, to form an adjusted virtual intrinsic capacity of the product, the virtual intrinsic capacity of the product at the virtual store, wherein the second volume is due to a sale of a second product in combination with the product at the virtual store;
adjusting by a third volume, to form an adjusted second virtual intrinsic capacity of the second product, a second virtual intrinsic capacity of the second product at the virtual store, wherein the third volume is due to a sale of the product in combination with the second product at the virtual store; and
outputting as a part of a matrix of product combinations (i) a product combination of the product and the second product, and (ii) the adjusted virtual intrinsic capacity of the product and the adjusted second virtual intrinsic capacity of the second product.

3. The method of claim 2, further comprising:
recommending deploying the product and the second product in combination for sale at the store;
setting a combination target volume for the product at the adjusted virtual intrinsic capacity of the product; and
setting a second combination target volume for the second product at the adjusted second virtual intrinsic capacity of the product.

4. The method of claim 1, wherein the setting as the upper threshold of target volume is responsive to the sold volume of the product at the store being less than the virtual intrinsic capacity of the product at the virtual store.

5. The method of claim 1, further comprising:
computing the virtual intrinsic capacity of the product at the virtual store by proportionately combining the modified intrinsic capacities of the product at the area stores in the sub-subset of area stores.

6. The method of claim 1, wherein the sold volumes of the product in different area stores in the sub-subset are affected differently by a common factor in the subset of factors.

7. The method of claim 1, wherein the sold volumes of the product in different area stores in the sub-subset are affected by different subset of factors.

8. The method of claim 1, wherein the factor is an income demographic of the geographic portion.

9. The method of claim 1, wherein the factor is a ratio of a price of the product at the store and a price of the product at a competing store in the geographical portion.

10. The method of claim 1, further comprising:
determining that the second product increases the sale of the product by the first volume, wherein the adjusting the sold volume comprises removing the first volume from the sold volume of the product at the area store.

11. The method of claim 1, further comprising:
determining that the second product decreases the sale of the product by the first volume, wherein the adjusting the sold volume comprises adding the first volume to the sold volume of the product at the area store.

12. The method of claim 1, wherein each area store in the set of area stores is located within the geographical area.

13. The method of claim 1, wherein the geographical portion is within the geographical area.

14. The method of claim 1, wherein the method is embodied in a computer program product comprising one or more computer-readable storage devices and computer-readable program instructions which are stored on the one or more computer-readable tangible storage devices and executed by one or more processors.

15. The method of claim 1, wherein the method is embodied in a computer system comprising one or more processors, one or more computer-readable memories, one or more computer-readable storage devices and program instructions which are stored on the one or more computer-readable storage devices for execution by the one or more processors via the one or more memories and executed by the one or more processors.

16. A computer program product comprising one or more computer-readable storage devices, and program instructions stored on at least one of the one or more storage devices, the stored program instructions comprising:
program instructions to collect, for a product at a store in a geographical portion of a geographical area, a set of factors, each factor in the set of factors affecting a sold volume of the product;
program instructions to identify a subset of a set of area stores such that each area store in the subset of area stores has a corresponding sold volume of the product;
program instructions to compute an intrinsic capacity of the product by adjusting the sold volume corresponding to an area store by a first volume wherein the first volume is due to a sale of a second product at the area store;
program instructions to select from the subset of area stores, a sub-subset of area stores wherein the sold volume corresponding to an area store in the sub-subset is affected by at least a subset of the set of factors, the sub-subset including the area store;
program instructions to modify, to compute a modified intrinsic capacity, an effect of a factor from the subset of factors on the intrinsic capacity of the product such that the effect is worse than an effect of the factor at the store;
program instructions to construct a virtual store using modified intrinsic capacities of the sub-subset of area stores; and
program instructions to set as an upper threshold of target volume of the product at the store, a virtual intrinsic capacity of the product at the virtual store.

17. The computer program product of claim 16, further comprising:
program instructions to adjust by a second volume, to form an adjusted virtual intrinsic capacity of the product, the virtual intrinsic capacity of the product at the virtual store, wherein the second volume is due to a sale of a second product in combination with the product at the virtual store;
program instructions to adjust by a third volume, to form an adjusted second virtual intrinsic capacity of the second product, a second virtual intrinsic capacity of the second product at the virtual store, wherein the third volume is due to a sale of the product in combination with the second product at the virtual store; and
program instructions to output as a part of a matrix of product combinations (i) a product combination of the product and the second product, and (ii) the adjusted virtual intrinsic capacity of the product and the adjusted second virtual intrinsic capacity of the second product.

18. The computer program product of claim 17, further comprising:
program instructions to recommend deploying the product and the second product in combination for sale at the store;
program instructions to set a combination target volume for the product at the adjusted virtual intrinsic capacity of the product; and
program instructions to set a second combination target volume for the second product at the adjusted second virtual intrinsic capacity of the product.

19. The computer program product of claim 16, wherein the program instructions to set as the upper threshold of target volume is responsive to the sold volume of the product at the store being less than the virtual intrinsic capacity of the product at the virtual store.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to collect, for a product at a store in a geographical portion of a geographical area, a set of factors, each factor in the set of factors affecting a sold volume of the product;
program instructions to identify a subset of a set of area stores such that each area store in the subset of area stores has a corresponding sold volume of the product;
program instructions to compute an intrinsic capacity of the product by adjusting the sold volume corresponding to an area store by a first volume wherein the first volume is due to a sale of a second product at the area store;
program instructions to select from the subset of area stores, a sub-subset of area stores wherein the sold volume corresponding to an area store in the sub-subset is affected by at least a subset of the set of factors, the sub-subset including the area store;
program instructions to modify, to compute a modified intrinsic capacity, an effect of a factor from the subset of factors on the intrinsic capacity of the product such that the effect is worse than an effect of the factor at the store;
program instructions to construct a virtual store using modified intrinsic capacities of the sub-subset of area stores; and
program instructions to set as an upper threshold of target volume of the product at the store, a virtual intrinsic capacity of the product at the virtual store.
